(19) United States
(12) Patent Application Publication
(10) Pub. No.: US 2019/0128547 A1
(43) Pub. Date: May 2, 2019

(54) DETERMINING A CAUSE OF A FAULT IN AN HVAC SYSTEM

(71) Applicant: Honeywell International Inc., Morris Plains, NJ (US)

(72) Inventors: Chunfu Li, Beijing (CN); Anjan Chaudhuri, Dubai (AE); John Boothroyd, North Ryde (AU)

(21) Appl. No.: 16/177,938

(22) Filed: Nov. 1, 2018

Related U.S. Application Data
(60) Provisional application No. 62/580,282, filed on Nov. 1, 2017.

(51) Int. Cl. F24F 11/38; F24F 11/64; G05B 19/042

(52) U.S. Cl. CPC F24F 11/38; G05B 2219/2614; G05B 19/042; F24F 11/64

(57) ABSTRACT

Devices, methods, and systems for determining a cause of a fault in a heating, ventilation, and air conditioning (HVAC) system are described herein. One device includes a memory, and a processor configured to execute executable instructions stored in the memory to receive operational data associated with an HVAC system, store the received operational data in a database, determine, upon a fault occurring in the HVAC system, a cause of the fault by applying the operational data in the database to a table that maps causes of possible faults that may occur in the HVAC system and symptoms corresponding to each respective possible fault, and provide the cause of the fault occurring in the HVAC system to a user.

### PRIORITY INFORMATION

This application is a Non-Provisional of U.S. Provisional Application No. 62/580,282, filed Nov. 1, 2017, the contents of which are incorporated herein by reference.

### TECHNICAL FIELD

The present disclosure relates generally to devices, methods, and systems for determining a cause of a fault in an HVAC system.

### BACKGROUND

A heating, ventilation, and air conditioning (HVAC) system can be used to control the environment within a facility (e.g., building). For example, an HVAC system can include a number of components (e.g., equipment, sensors, operating panels, controllers, actuators, etc.) that can be used to control the air temperature of different zones (e.g., rooms, areas, spaces, and/or floors) of a facility, in order to keep the zones in a comfort state for their occupants.

During operation of an HVAC system, however, faults in the HVAC system (e.g., in different components of the HVAC system) may sometimes occur. Detecting and correcting faults in the HVAC system can be important to provide a comfortable environment for the occupants of the facility, to prevent the fault from causing further damage to the HVAC system, and/or to avoid inefficient operation of the HVAC system which may result in higher energy consumption, for example.

In order to quickly and effectively correct a fault in an HVAC system, the cause (e.g., root cause) of the fault must be determined. However, previous approaches may focus on the symptoms (e.g., operational conditions) that may result from (e.g., be caused by) the fault, rather than the cause of the fault itself. For instance, in previous approaches when a fault occurs, an alarm may be generated that includes only the symptoms of the fault, and not the cause of the fault. Accordingly, in such previous approaches, it can be difficult, time consuming, and/or costly to determine the cause of the fault, as the symptoms of the fault may not be immediately indicative of the root cause of the fault.

### BRIEF DESCRIPTION OF THE DRAWINGS

FIG. 1 illustrates an example of a system for determining a cause of a fault in an HVAC system in accordance with an embodiment of the present disclosure.

FIG. 2 illustrates an example air handling unit of an HVAC system in accordance with an embodiment of the present disclosure.

FIG. 3 illustrates an example of a table for mapping causes of possible faults that may occur in an HVAC system and symptoms corresponding to each respective possible fault in accordance with an embodiment of the present disclosure.

FIG. 4 illustrates an example of a method for determining a cause of a fault in an HVAC system in accordance with an embodiment of the present disclosure.

FIG. 5 illustrates an example of a computing device for determining a cause of a fault in an HVAC system in accordance with an embodiment of the present disclosure.

### DETAILED DESCRIPTION

Devices, methods, and systems for determining a cause of a fault in a heating, ventilation, and air conditioning (HVAC) system are described herein. For example, an embodiment includes a memory, and a processor configured to execute executable instructions stored in the memory to receive operational data associated with an HVAC system, store the received operational data in a database, determine, upon a fault occurring in the HVAC system, a cause of the fault by applying the operational data in the database to a table that maps causes of possible faults that may occur in the HVAC system and symptoms corresponding to each respective possible fault, and provide the cause of the fault occurring in the HVAC system to a user.

Embodiments of the present disclosure can be used to determine the cause (e.g., the root cause) of a fault occurring in an HVAC system, and correct the fault, in an easier, cheaper, and/or less time consuming manner than previous approaches. For example, in embodiments of the present disclosure, the cause of a fault occurring in an HVAC system can be determined and provided to a user, in contrast with previous approaches in which only the symptoms of the fault, and not the cause of the fault itself, may be provided to the user. Accordingly, embodiments of the present disclosure can enable the fault to be corrected quickly and effectively, and thereby maintain a comfortable environment for the occupants of the facility, prevent the fault from causing further damage to the HVAC system, and/or avoid inefficient operation of the HVAC system which may result in higher energy consumption.

In the following detailed description, reference is made to the accompanying drawings that form a part hereof. The drawings show by way of illustration how one or more embodiments of the disclosure may be practiced.

These embodiments are described in sufficient detail to enable those of ordinary skill in the art to practice one or more embodiments of this disclosure. It is to be understood that other embodiments may be utilized and that mechanical, electrical, and/or process changes may be made without departing from the scope of the present disclosure.

As will be appreciated, elements shown in the various embodiments herein can be added, exchanged, combined, and/or eliminated so as to provide a number of additional embodiments of the present disclosure. The proportion and the relative scale of the elements provided in the figures are intended to illustrate the embodiments of the present disclosure, and should not be taken in a limiting sense.

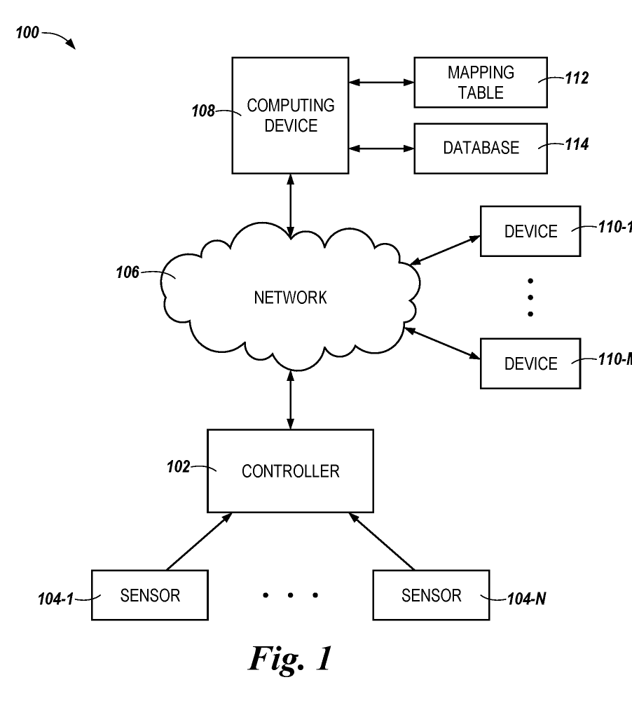

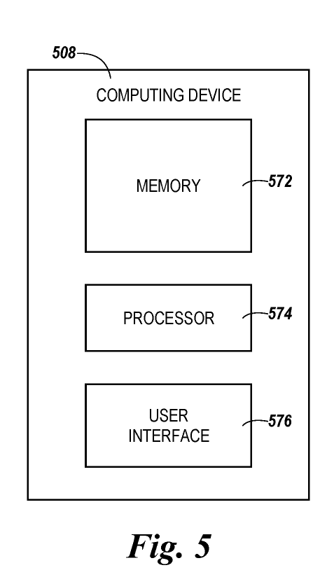

The figures herein follow a numbering convention in which the first digit or digits correspond to the drawing figure number and the remaining digits identify an element or component in the drawing. Similar elements or components between different figures may be identified by the use of similar digits. For example, 108 may reference element “08” in FIG. 1, and a similar element may be referenced as 508 in FIG. 5.

As used herein, “a” or “a number of” something can refer to one or more such things, while “a plurality of” something can refer to more than one such things. For example, “a number of faults” can refer to one or more faults, while “a plurality of faults” can refer to more than one fault. Additionally, the designators “N” and “M” as used herein, particularly with respect to reference numerals in the drawings, indicates that a number of the particular feature so designated can be included with a number of embodiments of the present disclosure.

FIG. 1 illustrates an example of a system 100 for determining a cause of a fault in an HVAC system in accordance with an embodiment of the present disclosure. The HVAC system can be, for example, the HVAC system of a facility (e.g., building), such as, for instance, a commercial office building. However, embodiments of the present disclosure are not limited to a particular type of facility.

The HVAC system can be used to control the environment within the facility. For example, the HVAC system can include a number of components that can be used to control the air temperature of different zones (e.g., rooms, areas, spaces, and/or floors) of a facility, in order to keep the zones in a comfort state for their occupants. The components of the HVAC system can include, for example, objects, control components (e.g., controllers), equipment (e.g., mechanical equipment), devices, networks, sensors, and/or actuators such as, for instance, valves such as heating and/or cooling valves, chillers (e.g., chiller plant), boilers (e.g., boiler plant), pumps such as hot water and/or chilled water pumps, fans, compressors, air dampers such as variable air volume (VAV) dampers, air handling units (AHUs) (e.g., AHU plant), coils such as heating and/or cooling coils, air filters, heat exchangers, and/or cooling towers, among other components. The HVAC system may also include connections (e.g., physical connections) between the components, such as a chain of equipment (e.g., duct work, pipes, ventilation, and/or electrical and/or gas distribution equipment) that connects the components, among other connections.

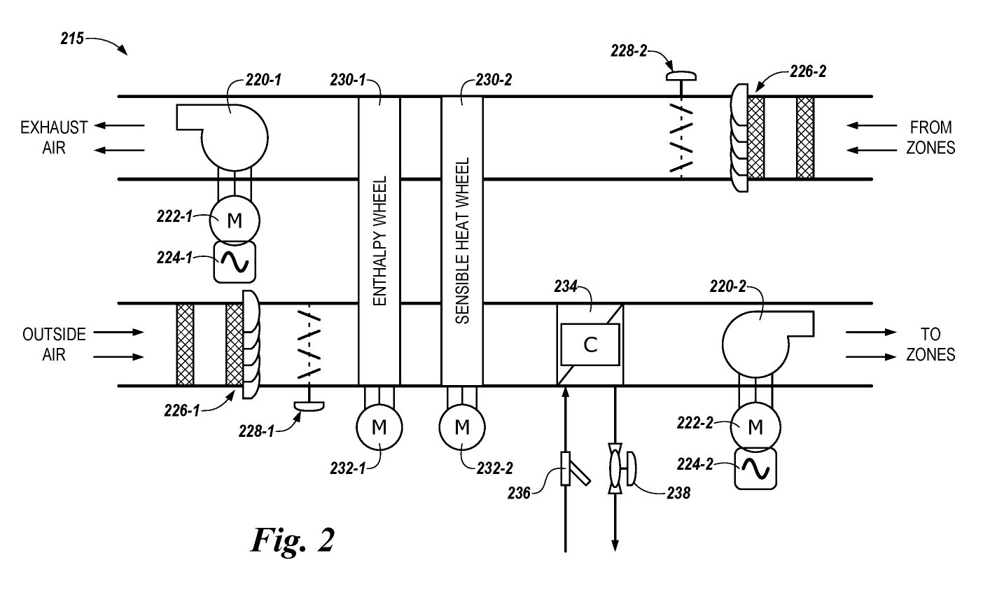

Further, the HVAC system can include (e.g., be divided into) a number of zones. The zones of the HVAC system can correspond to the zones of the facility, for example. An example of an HVAC system (e.g., of an AHU of an HVAC system) will be further described herein (e.g., in connection with FIG. 2).

As shown in FIG. 1, system 100 can include a controller 102. Controller 102 can be, for example, a controller of the HVAC system of the facility. For example, controller 102 can be used to check and/or set the state of the components, component connections, and/or zones of the HVAC system. Although one controller is illustrated in FIG. 1, embodiments of the present disclosure are not so limited (e.g., system 100 and/or the HVAC system can include a number of controllers analogous to controller 102).

Controller 102 can collect data, such as, for instance, real-time operational data, associated with the HVAC system. For example, controller 102 can receive the data from the components of the HVAC system, such as, for instance, sensors 104-1, . . . , 104-N illustrated in FIG. 1. Such data can include, for instance, current quantities, statuses, and/or properties of the components, component connections, and/or zones of the HVAC system.

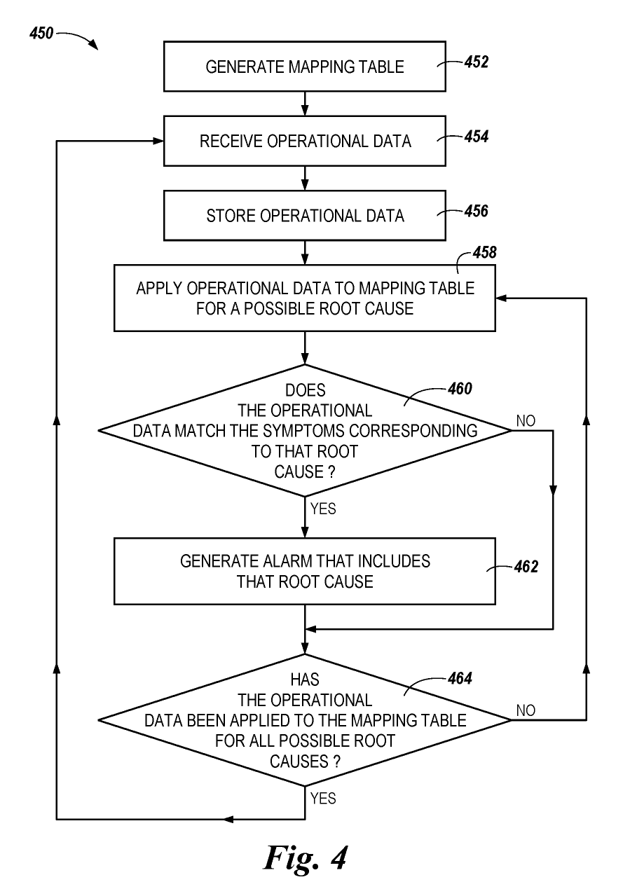

As shown in FIG. 1, system 100 can include a computing device 108. Computing device 108 can be part of a centralized analytics service (e.g., servers and/or databases) that is located remotely from the HVAC system and/or controller 102, and will be further described herein (e.g., in connection with FIG. 4).

As shown in FIG. 1, controller 102 can send (e.g., push) the collected data to computing device 108 via network 106 (e.g., computing device 108 can receive the data from controller 102 via network 106). Network 106 can be a wired or wireless network. For example, network 106 can be a network relationship through which computing device 108 and controller 102 can communicate. Examples of such a network relationship can include a distributed computing environment (e.g., a cloud computing environment), a wide area network (WAN) such as the Internet, a local area network (LAN), a personal area network (PAN), a campus area network (CAN), or metropolitan area network (MAN), among other types of network relationships. For instance, the network can include a number of servers that receive the data collected by controller 102, and transmit the received data to computing device 108 via a wired or wireless network.

As used herein, a “network” can provide a communication system that directly or indirectly links two or more computers and/or peripheral devices and allows users to access resources on other computing devices and exchange messages with other users. A network can allow users to share resources on their own systems with other network users and to access information on centrally located systems or on systems that are located at remote locations. For example, a network can tie a number of computing devices together to form a distributed control network (e.g., cloud).

A network may provide connections to the Internet and/or to the networks of other entities (e.g., organizations, institutions, etc.). Users may interact with network-enabled software applications to make a network request, such as to get a file or print on a network printer. Applications may also communicate with network management software, which can interact with network hardware to transmit information between devices on the network.

As shown in FIG. 1, system 100 can include a table (e.g., mapping table) 112 and database 114. Although mapping table 112 and database 114 are illustrated as being located outside of (e.g., separate from) computing device 108, embodiments of the present disclosure are not so limited. For example, in some embodiments, mapping table 112 and/or database 114 may be included in computing device 108.

The operational data received by computing device 108 can be stored in database 114. For instance, computing device 108 can continuously (e.g., in real time) receive the operational data, and continuously store the received operational data in database 114.

Mapping table 112 can map causes of possible faults that may occur in the HVAC system (e.g., in the equipment of the HVAC system) and symptoms corresponding to each respective possible fault. For example, mapping table 112 can include a list of possible faults that may occur in the HVAC system, such as, for instance, a list of possible root causes of faults that may occur in each type of equipment in the HVAC system, and an identification of the symptoms corresponding to each respective possible fault in the list.

As used herein, a fault in the HVAC system can include and/or refer to a component (e.g., equipment) of the HVAC system functioning improperly and/or causing abnormal behavior in the HVAC system and/or facility, and/or to an event that occurs to cause the component to function improperly or cause the abnormal behavior. For example, a fault in the HVAC system can include and/or refer to a component of the HVAC system breaking down, malfunctioning, ceasing to operate correctly, or operating in an unexpected manner. As an additional example, a fault can include and/or refer to abnormal (e.g., anomalous) behavior of the component.

As used herein, a symptom corresponding to a fault can include and/or refer to an operational condition(s) of the HVAC system that results from (e.g., is caused by) the fault. In contrast, as used herein, a cause of a fault can include and/or refer to the root cause of a fault that is causing a particular symptom or symptoms to occur. For instance, correcting the cause of a fault will result in the corresponding symptoms of the fault no longer occurring, but correcting the symptoms corresponding to a fault will not necessarily mean the fault itself has been corrected.

As an example, the cause of a fault occurring in the HVAC system may be a stuck cooling valve, while the symptoms corresponding to such a fault may include high discharge air temperature and an overheating AHU. Additional examples of the causes of possible faults and their corresponding symptoms will be further described herein.

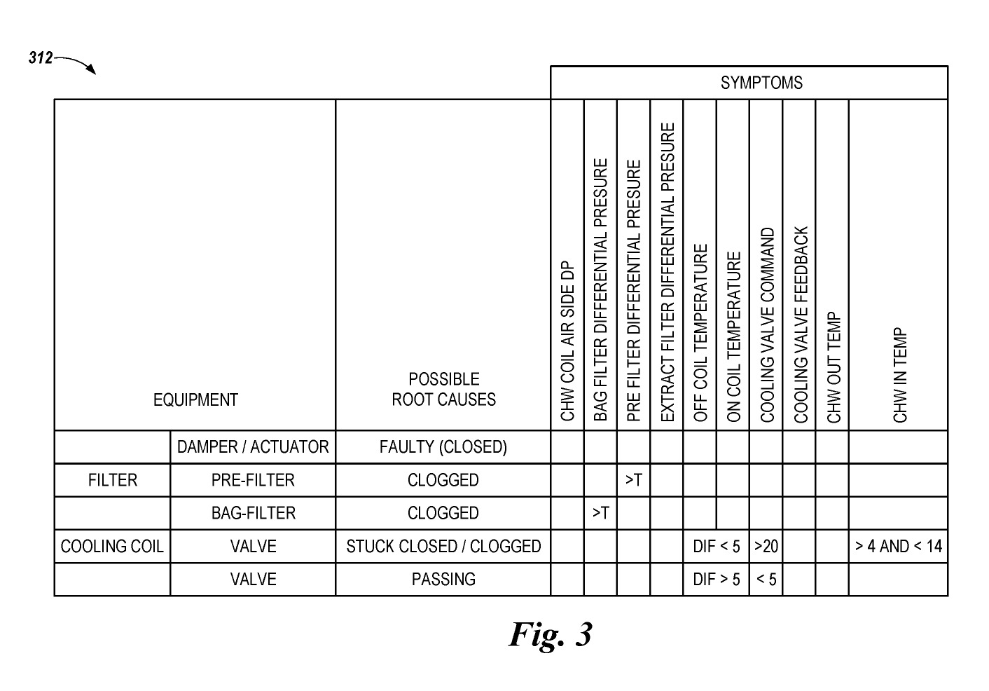

The symptoms included in mapping table 112 can include, for example, a particular operational data point of the operational data in database 114 being higher or lower than a particular value (e.g. threshold), the difference between two particular operational data points of the operational data in database 114 being greater than or less than a particular value, and/or a particular operational data point of the operational data in database 114 being true or false. An example of mapping table 112 (e.g., of the mapping of causes of possible faults that may occur in the HVAC system and symptoms corresponding to each respective possible fault) will be further described herein (e.g., in connection with FIG. 3).

Mapping table 112 can be generated (e.g., defined), for example, based on input received from a user. For instance, mapping table 112 can be generated based on the domain knowledge and/or expert experience of users associated with the setup (e.g., installation) and/or operation of the HVAC system, such as, for instance, a facility manager and/or engineer.

Upon a fault occurring in the HVAC system (e.g., in the equipment of the HVAC system), computing device 108 can determine a cause (e.g., the root cause) of the fault by applying the operational data stored in database 114 to mapping table 112. For example, computing device 108 can determine whether the operational data stored in database 114 matches the symptoms corresponding to any of the possible faults in mapping table 112, and determine, upon determining that the operational data matches the symptoms corresponding to one of the possible faults, that the cause of that possible fault in mapping table 112 is the cause of the fault occurring in the HVAC system. That is, the cause of the possible fault in mapping table 112 whose corresponding symptoms are determined to match the operational data stored in database 114 can be determined to the cause of the fault occurring in the HVAC system. Computing device 108 can determine whether the operational data stored in database 114 matches the symptoms corresponding to any of the possible faults in mapping table 112 sequentially (e.g., one by one), as will be further described herein (e.g., in connection with FIG. 4).

In some embodiments, all the symptoms corresponding a possible fault in mapping table 112 need to match the operational data in database 114 in order for the cause of that possible fault to be determined to be the cause of the fault occurring in the HVAC system (e.g., the cause of a possible fault in mapping table 112 may not be determined to be the cause of the fault occurring in the HVAC system if the operational data matches some, but less than all, of that possible fault's corresponding symptoms). In such embodiments, computing device 108 can determine whether all the operational data stored in database 114 matches the symptoms corresponding to any of the possible faults in mapping table 112, and determine, upon determining that the operational data matches all the symptoms corresponding to one of the possible faults, that the cause of that possible fault in mapping table 112 is the cause of the fault occurring in the HVAC system. Such embodiments can reduce the noise impact and/or prevent false positives (e.g., an erroneous determination that the cause of a possible fault in mapping table 112 is the cause of the fault occurring in the HVAC system when, in fact, the cause of that possible fault is not the cause of the fault occurring in the HVAC system).

In some embodiments, the symptoms corresponding a possible fault in mapping table 112 need to match the operational data in database 114 for a particular amount (e.g., period) of time in order for the cause of that possible fault to be determined to be the cause of the fault occurring in the HVAC system (e.g., the cause of a possible fault in mapping table 112 may not be determined to be the cause of the fault occurring in the HVAC system if the operational data matches that possible fault's corresponding symptoms for less than that amount of time). In such embodiments, computing device 108 can determine whether the operational data stored in database 114 matches the symptoms corresponding to any of the possible faults in mapping table 112 for the particular amount of time, and determine, upon determining that the operational data matches the symptoms corresponding to one of the possible faults for that amount of time, that the cause of that possible fault in mapping table 112 is the cause of the fault occurring in the HVAC system. The particular amount of time can be, for instance, 15 minutes. Such embodiments can reduce the noise impact and/or prevent false positives.

Once the cause of the fault occurring in the HVAC system has been determined, computing device 108 can provide the cause of the fault to a user (e.g., a technician, operator, or facility manager of the HVAC system), and/or can correct (e.g., take action to correct) the cause of the fault. For example, computing device 108 can generate an alarm for the fault occurring in the HVAC system that includes the determined cause of the fault, and send (e.g., transmit) the alarm to a device 110-1, . . . , 110-M of the user via network 106, as illustrated in FIG. 1. The alarm with the cause of the fault can then be displayed to the user on the user interface of the device 110-1, . . . , 110-M. Device 110-1, . . . , 110-M can be, for example, a computing device (e.g. a service management system portal computing device or a customer portal computing device), such as a desktop or laptop computer, or a mobile device, such as a smart phone or tablet.

In some embodiments, computing device 108 can determine whether the fault occurring in the HVAC system is a critical fault that may need a fast action and/or response. In such embodiments, the alarm generated by computing device 108 and sent to device 110-1, . . . , 110-M can include an indication of whether the fault is such a critical fault.

Computing device 108 may receive input for correcting (e.g., instructions on how to correct) the cause of the fault from the user, and correct the cause of the fault responsive to receiving the input. For instance, computing device 108 may receive the input from device 110-1, . . . , 110-M via network 106 (e.g., the user may enter the input into device 110-1, . . . , 110-M, which may then transmit the input to computing device 108 via network 106).

FIG. 2 illustrates an example air handling unit (AHU) 215 of an HVAC system in accordance with an embodiment of the present disclosure. The HVAC system can be, for instance, the HVAC system previously described in connection with FIG. 1 (e.g., an HVAC system in which a fault is occurring).

As shown in FIG. 2, AHU 215 can include a number of components (e.g., equipment). For example, AHU can include blowers 220-1 and 220-2 powered by motors 222-1 and 222-2 running on current 224-1 and 224-2, respectively, filters 226-1 and 226-2, dampers 228-1 and 228-2, enthalpy wheel 230-1 and sensible heat wheel 230-2 powered by motors 232-1 and 232-2, respectively, coil 234, strainer 236, and valve 238. As shown in FIG. 2, outside air can pass through (e.g., be filtered by) filter 226-1 and damper 228-1, be heated or cooled using coil 234, and be supplied to the zones of the HVAC system by blower 220-2. Further, return air from the zones can pass through filter 226-2 and damper 228-2, and be exhausted by blower 220-1.

During the operation of AHU 215, faults may occur in the components of AHU 215. For example, filters 226-1 and/or 226-2 may become dirty or clogged, dampers 228-1 and/or 228-2 may become stuck, strainer 236 may become clogged, valve 238 may become stuck or clogged, coil 234 become clogged, and/or motors 232-1 and/or 232-2 may trip, among other faults. Such faults may result in (e.g., cause) symptoms such as, for instance, motors 220-1 and/or 220-2 operating at a high current, high vibration, and/or wrong rotation, the supply water to coil 234 being too hot or too cold, coil 234 leaking water, coil 234 under or over cooling the air, and/or the air supplied to the zones of the HVAC system being an improper temperature (e.g., too hot or too cold) and/or being supplied at an improper flow (e.g., pressure).

FIG. 3 illustrates an example of a table (e.g., mapping table) 312 for mapping causes of possible faults that may occur in an HVAC system and symptoms corresponding to each respective possible fault in accordance with an embodiment of the present disclosure. Table 312 can be, for example, a portion of mapping table 112 previously described in connection with FIG. 1, and can be an example of a portion of a mapping table for AHU 215 previously described in connection with FIG. 2.

As shown in FIG. 3, mapping table 312 can include a list of possible root causes of faults that may occur in the equipment of AHU 215, including, for instance, a faulty (e.g., closed) damper or actuator, a clogged filter (e.g., clogged pre-filter and/or bag-filter), a stuck closed or clogged cooling coil valve, and a passing cooling coil valve. Further, mapping table 312 can include an identification of the symptoms corresponding to each respective possible fault in the list.

For instance, in the example illustrated in FIG. 3, the symptoms corresponding to a clogged pre-filter can include the pre-filter differential pressure being equal to or greater than a particular pressure threshold, and the symptoms corresponding to a clogged bag-filter can include the bag-filter differential pressure being equal to or greater than a particular pressure threshold. Further, the symptoms corresponding to a stuck closed or clogged cooling coil valve can include the difference between the off coil temperature and on coil temperature being less than five degrees, the number of cooling valve commands being greater than 20, and the supply water (e.g., CHW IN) temperature to the coil being greater than four degrees and less than 14 degrees. Further, the symptoms corresponding to a passing cooling coil valve can include the difference between the off and on coil temperature being greater than five degrees, and the number of cooling valve command being less than five.

As previously described in connection with FIG. 1, if the operational data stored in database 114 matches the (e.g., all of the) symptoms corresponding to one of the possible faults in mapping table 312, then that fault can be determined to be the root cause of the fault occurring in the HVAC system. For example, if the operational data stored in database 114 includes a pre-filter differential pressure of equal to or greater than the particular pressure threshold, it can be determined that a clogged pre-filter is the root cause of the fault occurring in the HVAC system. Further, if the operational data stored in database 114 includes a bag-filter differential pressure of equal to or greater than the particular pressure threshold, it can be determined that a clogged bag-filter is the root cause of the fault occurring in the HVAC system. Further, if the operational data stored in database 114 includes an off coil temperature and an on coil temperature having a difference of less than five degrees, a number of cooling valve commands being greater than 20, and a CHW IN temperature being greater than four degrees and less than 14 degrees, it can be determined that a stuck closed or clogged cooling coil valve is the root cause of the fault occurring in the HVAC system. Further, if the operational data stored in database 114 includes an off coil temperature and an on coil temperature having a difference of greater than five degrees, and a number of cooling valve commands being less than five, it can be determined that a passing cooling coil valve is the root cause of the fault occurring in the HVAC system.

FIG. 4 illustrates an example of a method 450 for determining a cause of a fault in an HVAC system in accordance with an embodiment of the present disclosure. Method 450 can be performed, for example, by computing device 108 previously described in connection with FIG. 1.

At block 452, method 450 includes generating a mapping table. The mapping table can be, for example, mapping table 112 and/or 312 previously described in connection with FIGS. 1 and 3, respectively, and can map causes (e.g., root causes) of possible faults that may occur in the HVAC system and symptoms corresponding to each respective possible fault, as previously described herein.

At block 454, method 450 includes receiving operational data associated with the HVAC system. The operational data can be received from controller 102 previously described in connection with FIG. 1, as previously described herein.

At block 456, method 450 includes storing the operational data. The operational data can be stored in database 114 previously described in connection with FIG. 1, as previously described herein.

At block 458, method 450 includes applying the operational data to the mapping table for a root cause of a possible fault in the table. Applying the operational data to the mapping table for a possible root cause of a possible fault in the table can include, for example, determining whether the operational data matches the symptoms corresponding to the root cause of that possible fault in the mapping table, as previously described herein and illustrated at block 460 of method 450. If it is determined that the operational data matches the symptoms corresponding to the root cause of that possible fault, method 450 proceeds to block 462. If it is determined that the operational data does not match the symptoms corresponding to the root cause of that possible fault, method 450 proceeds to block 464.

At block 462, method 450 includes generating an alarm that includes the root cause of that possible fault. Although not shown in FIG. 4, the generated alarm can be sent to a device of a user, as previously described herein.

At block 464, method 450 includes determining whether the operational data has been applied to the mapping table for all possible root causes of all possible faults in the mapping table. If it is determined that the operational data has been applied to the mapping table for all possible root causes of all possible faults in the mapping table, method 450 returns to block 454. If it is determined that the operational data has not been applied to the mapping table for all possible root causes of all possible faults in the mapping table, method 450 returns to block 458, where the operational data is applied to the mapping table for a different possible root cause of a possible fault in the table. In such a manner, method 450 can determine whether the operational data matches the symptoms corresponding to each respective possible root cause of the possible faults in mapping table 112 sequentially (e.g., one by one).

FIG. 4 illustrates an example of a computing device 508 for determining a cause of a fault in an HVAC system in accordance with an embodiment of the present disclosure. Computing device 508 can be, for example, computing device 108 previously described in connection with FIG. 1, and can be a laptop computer, a desktop computer, or a mobile device (e.g., smart phone, tablet, PDA, etc.), for instance. However, embodiments of the present disclosure are not limited to a particular type of computing device.

As shown in FIG. 5, computing device 508 can include a memory 572 and a processor 574. Memory 572 can be any type of storage medium that can be accessed by processor 574 to perform various examples of the present disclosure. For example, memory 572 can be a non-transitory computer readable medium having computer readable instructions (e.g., computer program instructions) stored thereon that are executable by processor 574 to determine a cause of a fault in an HVAC system in accordance with the present disclosure. That is, processor 574 can execute the executable instructions stored in memory 572 to determine a cause of a fault in an HVAC system in accordance with the present disclosure.

Memory 572 can be volatile or nonvolatile memory. Memory 572 can also be removable (e.g., portable) memory, or non-removable (e.g., internal) memory. For example, memory 572 can be random access memory (RAM) (e.g., dynamic random access memory (DRAM) and/or phase change random access memory (PCRAM)), read-only memory (ROM) (e.g., electrically erasable programmable read-only memory (EEPROM) and/or compact-disk read-only memory (CD-ROM)), flash memory, a laser disk, a digital versatile disk (DVD) or other optical disk storage, and/or a magnetic medium such as magnetic cassettes, tapes, or disks, among other types of memory.

Further, although memory 572 is illustrated as being located in computing device 508, embodiments of the present disclosure are not so limited. For example, memory 572 can also be located internal to another computing resource (e.g., enabling computer readable instructions to be downloaded over the Internet or another wired or wireless connection).

As shown in FIG. 5, computing device 508 can include a user interface 576. A user (e.g., operator) of computing device 508, such as, for instance, a facility manager, operator, and/or technician of an HVAC system, can interact with computing device 408 via user interface 576. For example, user interface 576 can provide (e.g., display) information to, and receive information from (e.g., input by), the user of computing device 508.

In some embodiments, user interface 576 can be a graphical user interface (GUI) that can include a display (e.g., a screen) that can provide and/or receive information to and/or from the user of computing device 508. The display can be, for instance, a touch-screen (e.g., the GUI can include touch-screen capabilities). As an additional example, user interface 576 can include a keyboard and/or mouse the user can use to input information into computing device 508. Embodiments of the present disclosure, however, are not limited to a particular type(s) of user interface.

Although specific embodiments have been illustrated and described herein, those of ordinary skill in the art will appreciate that any arrangement calculated to achieve the same techniques can be substituted for the specific embodiments shown. This disclosure is intended to cover any and all adaptations or variations of various embodiments of the disclosure.

It is to be understood that the above description has been made in an illustrative fashion, and not a restrictive one. Combination of the above embodiments, and other embodiments not specifically described herein will be apparent to those of skill in the art upon reviewing the above description.

The scope of the various embodiments of the disclosure includes any other applications in which the above structures and methods are used. Therefore, the scope of various embodiments of the disclosure should be determined with reference to the appended claims, along with the full range of equivalents to which such claims are entitled.

In the foregoing Detailed Description, various features are grouped together in example embodiments illustrated in the figures for the purpose of streamlining the disclosure. This method of disclosure is not to be interpreted as reflecting an intention that the embodiments of the disclosure require more features than are expressly recited in each claim.

Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A computing device for determining a cause of a fault in a heating, ventilation, and air conditioning (HVAC) system, comprising:
a memory; and
a processor configured to execute executable instructions stored in the memory to:
receive operational data associated with an HVAC system;
store the received operational data in a database;
determine, upon a fault occurring in the HVAC system, a cause of the fault by applying the operational data in the database to a table that maps causes of possible faults that may occur in the HVAC system and symptoms corresponding to each respective possible fault; and
provide the cause of the fault occurring in the HVAC system to a user.

2. The computing device of claim 1, wherein applying the operational data in the database to the table includes determining whether the operational data matches the symptoms corresponding to any of the possible faults in the table.

3. The computing device of claim 2, wherein the cause of a possible fault in the table whose corresponding symptoms are determined to match the operational data is the cause of the fault occurring in the HVAC system.

4. The computing device of claim 1, wherein providing the cause of the fault occurring in the HVAC system to the user includes:
generating an alarm for the fault occurring in the HVAC system, wherein the alarm includes the cause of the fault occurring in the HVAC system; and
sending the alarm to a device of the user.

5. The computing device of claim 4, wherein the alarm includes an indication of whether the fault occurring in the HVAC system is a critical fault.

6. The computing device of claim 1, wherein:
the possible faults that may occur in the HVAC system include possible faults that may occur in equipment of the HVAC system; and
the fault occurring in the HVAC system is a fault occurring in the equipment of the HVAC system.

7. A computer implemented method for determining a cause of a fault in a heating, ventilation, and air conditioning (HVAC) system, comprising:
receiving, by a computing device, operational data associated with an HVAC system;
storing the received operational data in a database;
determining, by the computing device upon a fault occurring in the HVAC system, a cause of the fault by applying the operational data in the database to a table that maps causes of possible faults that may occur in the HVAC system and symptoms corresponding to each respective possible fault; and
correcting, by the computing device, the cause of the fault occurring in the HVAC system.

8. The method of claim 7, wherein the method includes generating the table based on input received from a user.

9. The method of claim 7, wherein the method includes:
continuously receiving, by the computing device, the operational data associated with the HVAC system; and
continuously storing the received operational data in the database.

10. The method of claim 7, wherein correcting the cause of the fault occurring in the HVAC system includes:
receiving, by the computing device from a user, input for correcting the cause of the fault occurring in the HVAC system; and
correcting, by the computing device, the cause of the fault responsive to receiving the input.

11. The method of claim 7, wherein the method includes receiving, by the computing device, the operational data associated with the HVAC system from a controller of the HVAC system via a network.

12. A system for determining a cause of a fault in a heating, ventilation, and air conditioning (HVAC) system, comprising:
a database having operational data associated with an HVAC system;
a table that maps causes of possible faults that may occur in the HVAC system and symptoms corresponding to each respective possible fault; and
a computing device configured to, upon a fault occurring in the HVAC system:
determine whether the operational data in the database matches the symptoms corresponding to any of the possible faults in the table; and
determine, upon determining that the operational data in the database matches the symptoms corresponding to one of the possible faults in the table, that the cause of that one of the possible faults in the table is the cause of the fault occurring in the HVAC system.

13. The system of claim 12, wherein the table includes:
a list of the possible faults that may occur in the HVAC system; and
an identification of the symptoms corresponding to each respective possible fault.

14. The system of claim 13, wherein the list includes the possible faults that may occur in each type of equipment of the HVAC system.

15. The system of claim 12, wherein the computing device is configured to:
determine whether the operational data in the database matches all the symptoms corresponding to any of the possible faults in the table; and
determine, upon determining that the operational data in the database matches all the symptoms corresponding to one of the possible faults in the table, that the cause of that one of the possible faults in the table is the cause of the fault occurring in the HVAC system.

16. The system of claim 12, wherein the computing device is configured to:
determine whether the operational data in the database matches the symptoms corresponding to any of the possible faults in the table for a particular amount of time; and
determine, upon determining that the operational data in the database matches the symptoms corresponding to one of the possible faults in the table for the particular amount of time, that the cause of that one of the possible faults in the table is the cause of the fault occurring in the HVAC system.

17. The system of claim 12, wherein the symptoms in the table include a particular operational data point of the operational data in the database being higher or lower than a particular value.

18. The system of claim 12, wherein the symptoms in the table include a difference between two particular operational data points of the operational data in the database being greater than or less than a particular value.

19. The system of claim 12, wherein the symptoms in the table include a particular operational data point of the operational data in the database being true or false.

20. The system of claim 12, wherein the computing device is configured to determine whether the operational data in the database matches the symptoms corresponding to any of the possible faults in the table sequentially.
